(19) United States
(12) Patent Application Publication
(10) Pub. No.: US 2025/0363603 A1
(43) Pub. Date: Nov. 27, 2025

(54) WIDE ANGLE LENS PERSPECTIVE DISTORTION REDUCTION

(71) Applicant: Dell Products L.P., Round Rock, TX (US)

(72) Inventors: Chien-Chih Liao, Taipei City (TW); Ghee Beng Ooi, Singapore (SG); Chih Hao Kao, Singapore (SG)

(73) Assignee: Dell Products L.P., Round Rock, TX (US)

(21) Appl. No.: 18/669,972

(22) Filed: May 21, 2024

(51) Int. Cl. G06T 5/80; G06T 3/40; G06V 40/16

(52) U.S. Cl. CPC G06T 5/80; G06T 3/40; G06T 2207/20132; G06T 2207/30201; G06V 40/161

(57) ABSTRACT

An information handling system supports video conferences with a wide field of view camera that generates a gallery of plural individual participants captured in the wide field of view and cropped to have a gallery window for each individual. Individuals captured in a central region of the field of view are cropped without correction of perspective distortion while individuals captured at the edge of the field of view have their cropped images corrected for perspective distortion by reference to a table with stored correction scales based upon the angles of a trapezoidal bounding box drawn around the individuals to support rapid and real time corrections.

### BACKGROUND OF THE INVENTION

### Field of the Invention

The present invention relates in general to the field of information handling system camera interactions, and more particularly to an information handling system camera wide angle lens perspective distortion reduction.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems include processing components that cooperate to process information, such as a central processing unit (CPU) that executes instructions to process information in cooperation with a random access memory (RAM) that stores the information. Desktop information handling systems have a stationary housing that interacts with an end user through peripheral devices, such as a peripheral display, keyboard and mouse. Portable information handling systems integrate a CPU and RAM in a portable housing along with a display, keyboard and touchpad to support mobile operations. Generally, portable information handling systems will also interface with peripheral input/output (I/O) devices similar to desktop systems.

One common peripheral device used with information handling system is a camera that captures videos to support videoconferencing. Cameras are sometimes included in a portable housing near the display and in a peripheral display. Cameras are also commonly used in a stand-alone mode of operation, such by clipping onto a peripheral display frame or on a stand placed near a peripheral display. In operation, the camera typically captures visual images that are communicated to the CPU through a cable interface, such as a Type C USB cable, or a wireless interface, such as a WIFI interface. The CPU executes a videoconferencing application, such as ZOOM or MICROSOFT TEAMS, which coordinates presentation of the video stream at the peripheral display and communication of the video stream through a network to other videoconference participants. One feature of such videoconferencing applications is that participants are presented in a “smart gallery” that shows each participant in an individual window. In some instances, one camera will capture a wide field of view in a conference room having multiple conference participants. To support the smart gallery of individual participants, the videoconferencing application recognizes facial features of each individual in the conference room and crops a head shot of each individual.

One difficulty with using cropped pictures of individuals is that the cropped pictures can suffer from perspective distortion that results in end user features presented in an unnatural manner. Generally, when a camera field of view exceeds 80 degrees, the outside edges tend to have some distortions in depth introduced by the camera lens. In a typical conference room, the camera will have a field of view of 110 degrees or greater to help ensure that all places at a conference room table are captured with the image captured by the camera. In such a configuration, the table seats closest to the camera will often fall outside of the 80 degree field of view so that perspective distortion will impact images captured of participants in those seats. The amount of perspective distortion is a function of the focal length of the lens and distance to the object, which results in different amounts of magnification for facial features that have different distances to the camera, such as nose and ears. This impact can be greater when the individual is oriented at an angle.

One approach to solve perspective distortion is to use multiple cameras with narrow fields of view that have the room image stitched together. This approach increases cost in hardware by using multiple cameras and uses greater computing power. The image tends to have artifacts from the stitching algorithm and the image quality of different cameras is difficult to synchronize, such as color and brightness. Another approach is to correct distortion with software editing of the image, such as by the SIGGRAPH 2019 algorithm. This algorithm uses a face detection to generate a full-picture subject mesh in three optimization phases to create a non-linear mesh. The algorithm is computationally intensive so that it is not practical to use in a video stream. Even with improvements to the algorithm, a processing time of 841 ms is typical for a single 1024×768 frame visual image using an INTEL W-2135 CPU.

### SUMMARY OF THE INVENTION

Therefore, a need has arisen for a system and method which corrects perspective distortion of visual images captured with a wide field of view lens in a timely manner adaptable to a video stream.

In accordance with the present invention, a system and method are provided which substantially reduce the disadvantages and problems associated with previous methods and systems for correcting perspective distortion in a video stream captured by a wide angle camera. Individuals in a predetermined portion of a wide field of view visual image have a correction applied to address perspective distortion by reference to a lookup table that associates scale factors to angular position.

More specifically, an information handling system processing resource and memory cooperate to correct visual images captured by a wide field of view camera to support presentation of a gallery of individuals participating in a video conference. Individuals cropped for the gallery from a central or inner range of angles of the camera field of view are communicated without correction for perspective distortion. Individuals in a predetermined outer angular range, such as greater than 80 degrees, have a correction scaling factor determined from a lookup table and applied to correct a trapezoidal bounding box to a rectangular shape having equal magnification on an inner and outer edge of the bounding box. In one example embodiment, the perspective distortion correction is only applied when the individual falls both in the outer angular range and at less than a predetermined distance to the camera, such as less than two meters.

The present invention provides a number of important technical advantages. One example of an important technical advantage is that correction of perspective distortion is provided in a rapid manner to support video streams, such as to crop individuals from a wide angle camera visual image to show the individuals in a gallery of videoconference participants. In one example embodiment, a 2 MB frame is corrected in 5.873 ms versus 841 ms when corrected by other conventional techniques. The correction is performed with a low complexity algorithm having a negligible footprint with minimal processing and latency. By defining a top line, base line and trapezoidal mapping to a rectangular correction, perspective distortion is rapidly corrected for auto framed cropped individuals by a rapid lookup table reference based upon pixel location of a visual image mapped to angles for the field of view of the camera that captures the visual image.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system configured to perform perspective distortion correction for visual images captured by a wide angle camera;

FIG. 2 depicts a conference room wide angle camera visual image capture for plural individuals at a range of field of view angles;

FIG. 3 depicts a flow diagram of a process for managing perspective distortion correction at cropped images captured by a wide angle camera, such as video conference room camera; and

FIG. 4 depicts a flow diagram of a process for rapid correction of cropped visual images from a wide angle camera with trapezoidal to rectangle bounding box adjustments by a scaling factor.

### DETAILED DESCRIPTION

Perspective distortion of visual images captured by a camera to support information handling system communication, such as a video conference, is corrected with a rapid table lookup. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

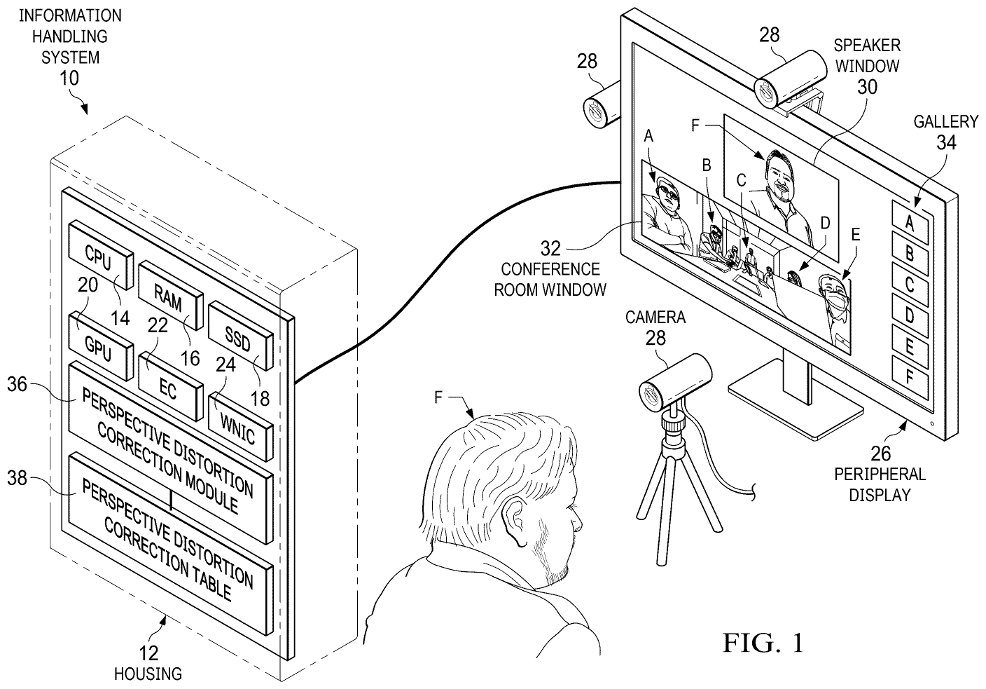

Referring now to FIG. 1, a block diagram depicts an information handling system 10 configured to perform perspective distortion correction for visual images captured by a wide angle camera 28. In the example embodiment, information handling system 10 has a stationary housing 12 to houses processing components that cooperate to process information. In alternative embodiments, information handling system 10 may have a portable housing that includes a keyboard, display and power source. A central processing unit (CPU) 14 executes instructions to process information in cooperation with a random access memory (RAM) 16 that stores the instructions and information. For example, a solid state drive (SSD) 18 or other non-transitory memory stores an operating system and applications that are retrieved to RAM 16 for execution by CPU 14 at power up by an embedded controller (EC) 22. A graphics processing unit (GPU) 20 provides further processing of the information to generate visual images for presentation at a peripheral display 26, such as by generating pixel values that define colors presented at an array of pixels of peripheral display 26. Embedded controller 22 manages physical operating conditions at the information handling system, such as power management, thermal management and communication with input/output (I/O) devices like a keyboard and mouse. A wireless network interface controller (WNIC) 24 supports network communication with external devices, such as through WIFI, Bluetooth and Ethernet.

In the example embodiment, information handling system 10 executes a videoconference application that communicates video streams captured by cameras 28. Video streams may be captured by a variety of different types of cameras 28 including a camera integrated in the bezel of peripheral display 26, a peripheral camera clipped to the bezel of peripheral display 26 and a stand-alone peripheral camera 28 on a stand near the peripheral display. Camera 28 captures an image of an end user, illustrated as individual F, who is speaking as a participant of a videoconference to individuals A, B, C, D, and E located in a distal conference room. When individual F is speaking, she is shown in a speaker window 30 while the other participant individuals are shown by a single camera feed of the conference room in a conference room window 32. In alternative embodiments, additional camera video stream feeds may be included in the videoconference application displayed user interface as additional windows. A gallery 34 is provided at one side of the videoconference application user interface which shows each individual A-F in their own gallery window, such as with a headshot or smaller-sized presentation of the camera feed. Gallery 34 individual gallery windows are typically supported by videoconference applications like ZOOM and TEAMS.

Gallery 34 windows of individuals A-E are cropped images taken from the video stream of a wide angle camera 28 that captures visual images in a conference room. Each cropped image shows one of the individuals in the conference room and is presented in a larger format in speaker window 30 when the individual becomes a speaker at the videoconference. For individual F as a single individual captured by a camera having a narrow field of view centered on individual F, the communication of a video stream is a direct process that need not include any processing adjustments of the video image. For individuals A through E, the video stream has some processing that crops each individual into a separate gallery window while also communicating all of the individuals as a group around a conference table in conference window 32. In order to capture an entire conference room with a single camera, a wide angle camera lens is used that has a “fish-eye” effect of capturing individuals at large outer angles and close ranges associated with conference room table seats located near the camera. In part, these close seats at the outer angles of the camera field of view tend to suffer from perspective distortion related to camera magnification. The present disclosure addresses the perspective distortion with rapidly applied corrections that have minimal impact on the video stream capture speed. A perspective distortion correction module 36 looks up a scale factor from a perspective distortion correction table 38 based upon a detected field of view angle of a bounding box used to crop an individual image for the gallery and applies the scaling factor to correct the perspective distortion. The processing to achieve gallery windows of individuals may be performed at a camera, such as with the camera's image sensor processor (ISP), at an information handling system executing a videoconference application, such as a CPU, GPU or application specific integrated circuit (ASIC), or at the information handling system that receives the conference room video stream.

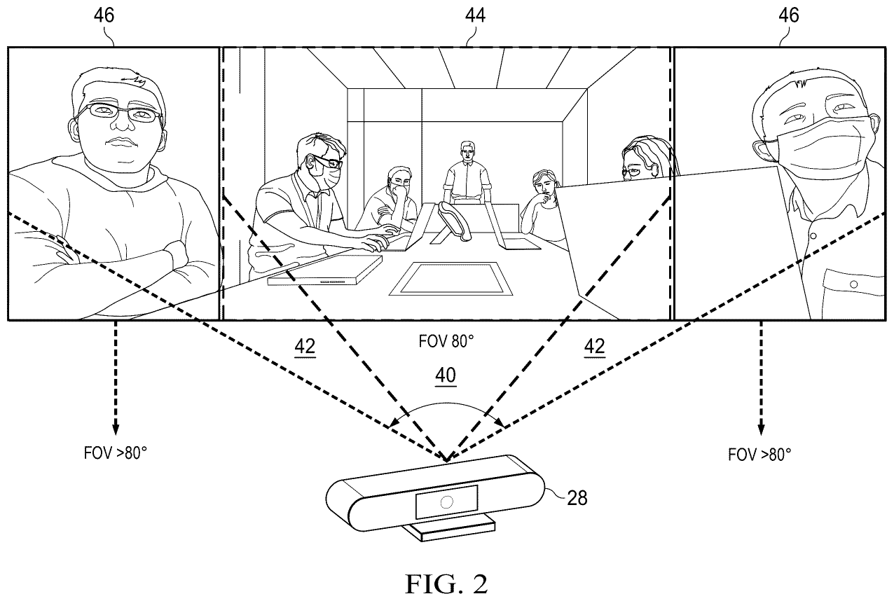

Referring now to FIG. 2, a conference room wide angle camera 28 visual image capture is depicted for plural individuals at a range of field of view angles. In an inner angle range 40 captured by camera 28, the amount of perspective distortion is relatively minor so that individuals 44 cropped from the central angle range are processed “as-is” without image processing to correct perspective distortion. In the example embodiment, the inner angle range is a total field of view of 80 degrees, or 40 degrees to each side of a central axis of camera 28. In the example embodiment, the total field of view is 120 degrees so that the outer angular range 42 is 20 degrees at each side of the captured visual image and individuals 46 in this angular range tend to have perspective distortion that impacts the quality of a cropped image so that correction of the perspective distortion will improve the quality of the cropped individual visual image enough to justify additional processing to perform the correction. Perspective distortion is a function of focal length and magnification provided by the wide angle lens. For instance, a lens equation that defines focal length is that the inverse of distance between an object and a lens plus the inverse of distance between a lens and an image sensor equals the inverse of the lens focal length. Magnification of the object by the lens is defined as a ratio of the distance between a lens and image sensor divided by the distance between the object and the lens. With wide angle lens where an object is located in relatively close proximity to the lens, a depth difference for different parts of the object, such as distance to a nose versus an ear of a human head, results in distortion due to differences in the magnification of the lens for the object at different depths. Perspective distortion increases at the outer angular range of the camera field of view since the distance increases to the object as a function of the hypotonus of the triangle defined by the lens central axis and the outer most angle. Specifically, the outer most angle distance is a function of the inverse of the cosine of the angle relative to the central camera axis. This mathematical relationship is leveraged to generate a table of scale up ratios to correct cropped visual images captured at greater than a predefined angle with a rapid processing step, as is described in greater detail below.

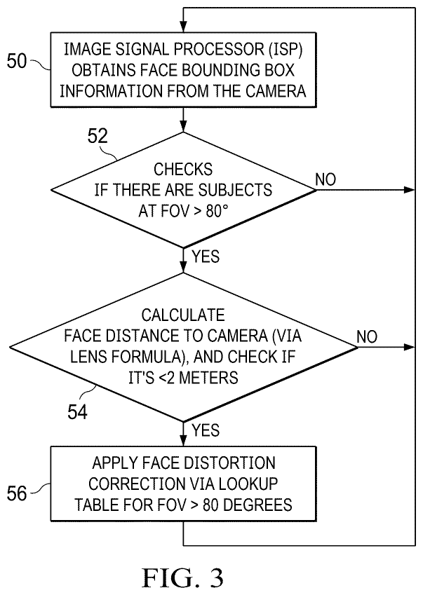

Referring now to FIG. 3, a flow diagram depicts a process for managing perspective distortion correction at cropped images captured by a wide angle camera, such as video conference room camera. The process starts at step 50 where the image signal processor (ISP) of the camera determines facial bounding box information from the captured visual image. The facial bounding box is determined by detecting human form, such as facial features or a head and shoulders silhouette in a conventional manner. Once all of the individuals in the conference room wide angle camera are identified, the process continues to step 52 to determine if any individuals identified in the camera field of view are found outside of an inner angular range field of view of 80 degrees, which is 40 degrees to each side of a central axis of the camera. When field of view angle of the bounding box is less than 80 degrees, perspective distortion correction is not performed since the amount of distortion is not significant to the human eye viewing the visual images and the process returns to step 50. When the bounding box field of view angle is greater than 80 degrees, the process continues to step 54 to determine if the face distance is less than two meters. When the distance is greater than two meters, the amount of perspective distortion is not significant to the human eye viewing the visual image so that perspective distortion correction is not performed and the process returns to step 50. At step 56 perspective distortion correction is performed by retrieving a scaling factor from a lookup table based upon the detected angle of the bounding box and or distance to the individual captured in the bounding box. Although the example embodiment has a threshold of 80 degrees and two meters at which perspective distortion correction is performed, greater or lesser angles and distances may be used based upon the quality of images captured, available processing resources, number of gallery pictures and the quality of the network interface. For example, when the gallery includes a large number of individuals, perspective distortion corrections may be limited to the very outside angles or a limited number of individuals selected from the largest to the lowest angle until a maximum number is selected. As another example, when the network connection is poor so that the corrections will have a limited impact, fewer of the gallery individuals may be corrected.

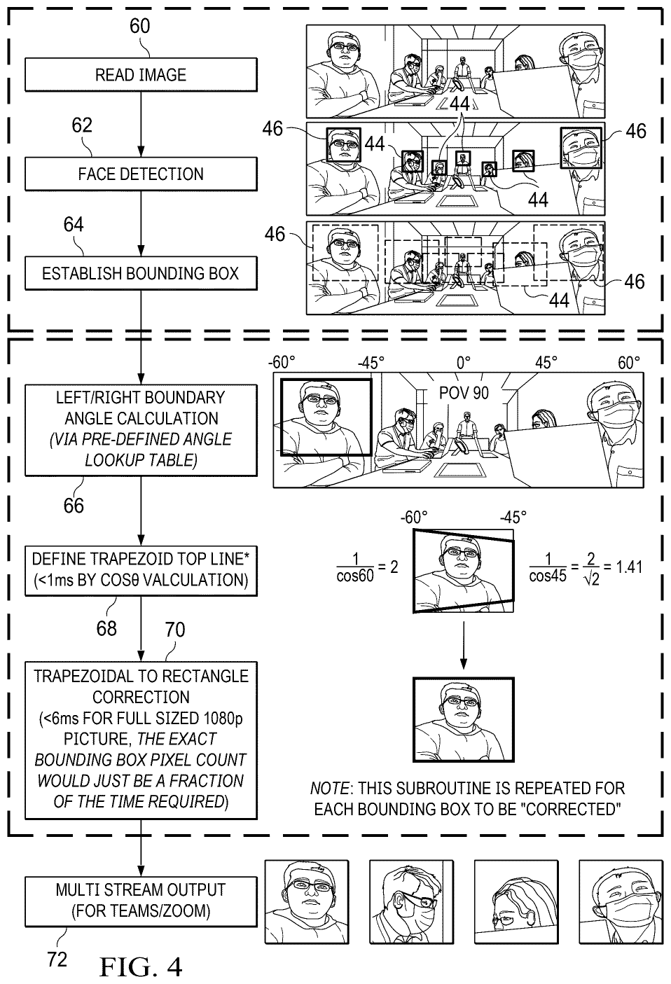

Referring now to FIG. 4, a flow diagram depicts a process for rapid correction of cropped visual images from a wide angle camera with trapezoidal to rectangle bounding box adjustments by a scaling factor. The process rapidly corrects perspective distortion by determining the exact location, coordinates and amount of pixels captured inside a bounding box and adjusting the pixel positions with a scaling factor that changes the bounding box to remove the perspective distortion. The process starts at step 60 by reading the visual image captured by the camera. At step 62 face detection is performed to find individuals in the visual image. In the example embodiment, four individuals 44 are located in the inner angular range and two individuals 46 are located in the outer angular range. At step 64 a bounding box is established around each identified individual, such as with auto framing. At step 66 a left and right boundary angle calculation is performed to determine the angular range of the bounding boxes that fall in the outer angular range of the visual image. In the example, the bounding box has an angular range of 60 to 45 degrees from a central zero axis. At step 68, a trapezoid top line is calculated by determining a scaling factor for the 60 degree side as two and a scaling factor for the 45 degree side as 1.41. The scaling factors reflect the amount of magnification created for each side of the bounding box where the outer side of the cropped image has a greater magnification than the inner side. At step 70 the trapezoidal to rectangle correction is performed by scaling up the inner side of the bounding box from the scaling factor of 1.41 to the scaling factor of 2. The scaling up of the bounding box to the rectangle shape adjusts the number of pixels to count in the bounding box and may be performed with a rapid calculation so that the bounding box has substantially the same magnification around all sides. At step 72 a multi-stream output is provided for each cropped individual with the corrected magnification applied when the bounding box is in the outer angular range and at a predetermined distance, such as two meters.

In one example embodiment, a rapid perspective distortion correction is performed by using the coordinates of the pixels of the bounding box with reference to the entire resolution to derive the individual's angle from the camera. For example, on a 1920 by 1080 resolution display the person at the 960^{th} pixel has zero degrees angle and is directly facing the camera. The first pixel in the array is −60 degrees for a 120 degree camera field of view that is presented on the entire display and the 1920^{th} pixel is positive 60 degrees. The lookup table references the offset angle and provides a nonlinear mapped curve for the camera field of view angles to a linear image at a predefined resolution. This arrangement allows a very rapid lookup for a camera to determine angles based on pixel position and apply a correction for the angles with a direct lookup to pixel positions.

Although the present invention has been described in detail, it should be understood that various changes, substitutions and alterations can be made hereto without departing from the spirit and scope of the invention as defined by the appended claims.

What is claimed is:

1. An information handling system comprising:
a processer operable to execute instructions to process information;
a memory interfaced with the processor and operable to store the instructions and information;
a network interface controller interfaced with the processor and operable to communicate the information through a network;
a camera operable to capture visual images within a field of view; and
a non-transitory memory storing instructions that when executed cause:
detection of plural individuals in the field of view;
for each of the plural individuals:
determination of location in a predetermined inner angular range of the field of view or a predetermined outer angular range of the field of view;
when in the inner angular range, cropping the individual for communication as a gallery window; and
when in the outer angular range, cropping the individual and correcting the cropping for perspective distortion for communication as a gallery window.

2. The information handling system of claim 1 further comprising:
instructions stored in the non-transitory memory that cause:
determination of a distance to each individual in the outer angular range; and
when the distance is greater than a predetermined amount, communication of the gallery window without correcting the perspective distortion; and
when the distance is less than a predetermined amount, correction of the perspective distortion before communication of the gallery window.

3. The information handling system of claim 2 wherein the perspective distortion correction comprises scaling a trapezoid bounding box defined around the individual to a rectangle shape.

4. The information handling system of claim 3 wherein the instructions further comprise a look up table storing plural angles in the outer angular range, each of the plural angles associated with a scaling factor for scaling the trapezoid bounding box.

5. The information handling system of claim 4 wherein inner angular range is 80 degrees.

6. The information handling system of claim 5 wherein the distance predetermined amount is two meters.

7. The information handling system of claim 3 wherein the trapezoid bounding box scaling comprises scaling up the bounding box inner angle scale to the bounding box outer angle scale.

8. The information handling system of claim 7 wherein the scale is the inverse of the cosine of the angle.

9. The information handling system of claim 2 wherein the instructions further:
detect a speaker is one of the individuals in the gallery having a corrected perspective distortion; and
present the cropping of the speaker with the corrected perspective distortion in a speaker window.

10. A method for capturing visual images with a camera having a field of view, the method comprising:
detecting plural individuals in the field of view;
for each of the plural individuals:
determining of a location in a predetermined inner angular range of the field of view or a predetermined outer angular range of the field of view;
when in the inner angular range, cropping the individual for communication as a gallery window; and
when in the outer angular range, cropping the individual and correcting the cropping for perspective distortion for communication as a gallery window.

11. The method of claim 10 further comprising:
determining of a distance to each individual in the outer angular range; and
when the distance is greater than a predetermined amount, communicating of the gallery window without correcting the perspective distortion; and
when the distance is less than a predetermined amount, correcting the perspective distortion before communicating of the gallery window.

12. The method of claim 11 wherein:
the inner angular range is eighty degrees; and
the distance is two meters.

13. The method of claim 11 wherein the correcting the perspective distortion further comprises:
defining a trapezoidal bounding box around the individual; and
correcting the trapezoidal bound box to a rectangle shape.

14. The method of claim 13 further comprising:
storing a correction table associated plural angles in the outer angular range with a scaling factor; and
scaling an inner angle side of the trapezoidal bounding box to the scaling factor of an outer angle side of the trapezoidal bounding box.

15. The method of claim 14 wherein the scale is the inverse of the cosine of the angle.

16. The method of claim 11 wherein the cropping the individual and correcting the cropping for perspective distortion are performed with an image sensor processing resource of a camera.

17. A videoconference system comprising:
a camera having a field of view;
a processing resource interfaced with the camera; and
a non-transitory memory storing instructions that when executed on the processing resource cause:
detection of plural individuals in the field of view;
for each of the plural individuals:
determination of location in a predetermined inner angular range of the field of view or a predetermined outer angular range of the field of view;
when in the inner angular range, cropping the individual for communication as a gallery window; and
when in the outer angular range, cropping the individual and correcting the cropping for perspective distortion for communication as a gallery window.

18. The videoconference system of claim 17 further comprising instructions stored in the non-transitory memory that cause:
determination of a distance to each individual in the outer angular range; and
when the distance is greater than a predetermined amount, communication of the gallery window without correcting the perspective distortion; and
when the distance is less than a predetermined amount, correcting the perspective distortion before communication of the gallery window.

19. The videoconference system of claim 18 further comprising:
a look up table storing plural angles in the outer angular range, each of the plural angles associated with a scaling factor for scaling a trapezoid bounding box around the individual to a rectangle shape.

20. The videoconference system of claim 19 wherein the instructions further:
detect a speaker is one of the individuals in the gallery having a corrected perspective distortion; and
present the cropping of the speaker with the corrected perspective distortion in a speaker window.
